(19) United States
(12) Patent Application Publication
(10) Pub. No.: US 2004/0147352 A1
(43) Pub. Date: Jul. 29, 2004

(54) Face gear and method of manufacturing the same

(75) Inventors: Tomoyuki Amano, Saitama (JP); Masatoshi Miyoshi, Saitama (JP); Koji Kikuchi, Tokyo (JP); Wataru Tsutsumi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: DAIWA SEIKO, INC.

(21) Appl. No.: 10/796,127

(22) Filed: Mar. 10, 2004

Related U.S. Application Data
(62) Division of application No. 10/210,049, filed on Aug. 2, 2002.

(51) Int. Cl. F16H 3/72

(52) U.S. Cl. 475/1

(57) ABSTRACT

According to the invention there is provided a face gear (10) for use in transmitting power between two shafts which are perpendicular to each other in an offset state, characterized in that tooth portions of the face gear are formed by a numerically controlled milling machine.

### BACKGROUND OF THE INVENTION

The present invention relates to a face gear used for a fishing reel represented by a spinning reel for fishing as well as a method of manufacturing the same.

Generally, a spinning reel for fishing is provided with a driving-force transmitting mechanism (winding drive mechanism) for transmitting the rotatively driving force of a handle to a rotor. The transmission of this driving force is effected as a gear provided on a handle shaft and a gear with a rotor attached thereto mesh with each other. Specifically, the rotor which is rotatably supported by a reel body and a spool which is provided in front of the rotor and around an outer periphery of which a fishing line is wound. The rotor rotates integrally with a pinion gear disposed on the outer peripheral side of a spool shaft, and the spool is reciprocated back and forth by an oscillating mechanism which is driven by means of an intermediate gear meshing with the pinion gear.

The shafts of rotation centers of the aforementioned handle shaft and the rotor have a special feature in that they are perpendicular to each other in an offset state. When the driving force is transmitted, a form is adopted in which a face gear is attached to the handle shaft, a pinion gear is attached to the portion of the rotation center of the rotor, and the two members are threadedly engaged with each other.

The application of the face gear of this type is very limited to such as a spinning reel for fishing and a rear rotor of a helicopter, and is generally formed by zinc casting, aluminum alloy casting and forging, stainless steel molding (metal injection molding (MIM)), or the like. Each of these methods is a molding or forming method which requires a mold or a die assembly.

The mold or die assembly for forming such a face gear is generally fabricated as follows. Namely, a pinion cutter is fabricated in advance by a cutting tool called a hob, this pinion cutter is then pressed against a copper material to fabricate an electrode for a mold having a tooth profile corresponding to the gear portion of the face gear, and a mold steel is subjected to electrical discharge machining using this electrode.

Alternatively, unlike such a method of forming the face gear, a method using machining is practiced. This is a method in which the face gear is formed by performing machining by a machine called a gear shaper. Specifically, a pinion cutter is fabricated in advance by a hob without using the mold or die assembly, and the teeth are cut one tooth at a time while the pinion cutter and the basic material of the face gear are being synchronously rotated.

In each of the aforementioned methods, so-called lapping is finally performed in which the tooth portions of the fabricated face gear are subjected to finish machining by a lapping pinion so as to form smooth tooth surfaces.

However, the face gears fabricated by the above-described methods suffer the following problems.

With the above-described method of molding or forming the face gear by using the mold or die assembly, since the electrode is fabricated by using a pinion cutter, and the mold or die assembly is fabricated subjecting a mold steel to electrical discharge machining by using this electrode, the accuracy of the tooth surfaces of the finally obtained face gear is poor. In addition, since shrinkage occurs in the casting or forging process, the mold or die assembly transferability is poor. For this reason, problems arise in that correction working is required after the molding or forming, that it takes time in the finishing process, and that variations of the finally molded or formed products are large, and the rate of occurrence of defective products is high.

In addition, since the shape of the tooth surface is determined by the mold or die assembly, in a case where the correction of the shape of the tooth surface is effected, the mold or die assembly must be corrected, and it is difficult to correct the tooth surfaces and tooth traces easily. Furthermore, there is a problem in that if the fluidity in the mold and the workability are taken into consideration (a basic material with a low melting point and excelling in fluidity in the case of casting, and a soft basic material in the case of forging), the materials which can be used are specified.

Meanwhile, with the above-described forming method using the gear shaper, since the working direction is inevitably fixed, burrs are likely to occur, and since deburring and chamfering cannot be effected with the gear shaper, correction working is required again. Consequently, the manufacturing process becomes complex, so that the manufacturing cost per piece becomes high. In addition, since the shape of the tooth surface is determined by the shape of the pinion cutter, a different cutter is required each time changes are made in the gear ratio and the tooth profile. Because correction of the tooth profile and tooth surfaces is difficult, and in view of the fact that cutting is effected by the pinion cutter, cutting resistance is large, so that this method is not suitable for the use of a high-strength material.

Further, if the tooth surfaces are formed in this manner, even if grease is applied to make the drive smooth and protect the tooth surfaces, the grease is likely to be forced out from the tooth surfaces. As a result, friction due to the running out of an oil film on the tooth surfaces, seizure at the time of a high load, and the like occur, so that there is a problem in that the durability of the face gear is poor. In addition, since the tooth surfaces of the face gear and the pinion gear are in surface contact with each other, the contact resistance becomes large, so that there occurs the problem that the rotation of the handle becomes heavy.

Further, with the above-described forming method using the gear shaper, since the tooth surfaces are determined by the shape of the pinion cutter, the tooth surfaces become uniform flat surfaces, so that the above-described problems can occur.

In addition, the above-described problems are not limited to the face gear of the spinning reel, and also apply to gears of various kinds used in the winding-power transmitting mechanism.

Further, if the tooth surfaces are formed as described above, since a relatively soft basic material is used in the case of casting or forging, there is a problem in the durability of the gear in that wear, seizure at the time of a high load, and the like are likely to occur. Consequently, the rotating performance declines. Incidentally, if the irregularities on the tooth surfaces are made uniform by the aforementioned lapping process, work-hardened layers are formed on the surfaces, but the layers are thin and are soon worn and disappears, so that the gear does not have sufficient durability.

In addition, although it is known to form the gear by machining, in this case, there are many cases where a material excelling in machinability is used, so that the drawback of such as the decline in the rotating performance due to the wear of the tooth surfaces is not overcome.

Furthermore, in the case of a gear using aluminum as a basic material, it is known to provide surface treatment by forming alumite on the surfaces to improve the wear resistance of the gear. However, the alumite layers become exfoliated together with the parent metal owing to the absolute lack of strength of the parent metal, with the result that the rotating performance declines.

### SUMMARY OF THE INVENTION

The invention has been devised in view of the above-described problems, and its object is to provide a high-accuracy face gear which is mainly used for a spinning reel for fishing or the like.

Another object of the invention is to provide a manufacturing method which makes it possible to manufacture such face gears easily on a stable basis without being limited by the material.

Further another object is to provide a fishing reel in which improvement is made in the durability of the gear by improving the grease holding capability, and which permits light handle operation.

Further another object is to provide a fishing reel in which improvement is made in the wear resistance of various gears used in the winding drive mechanism, and whose rotating performance is difficult to decline.

In order to solve the aforesaid object, the invention is characterized by having the following arrangement.

(1) A face gear for transmitting power between two shafts which are perpendicular to each other in an offset state comprising:

a plurality of tooth portions formed by a numerically controlled milling machine.

(2) The face gear according to (1), wherein an inclined surface is formed on a reverse side of a surface on which the plurality of tooth portions are formed, and at least a portion of the reverse surface located substantially directly in the rear of the plurality of tooth portions is formed into a flat surface parallel to the surface on which the plurality of tooth portions are formed.

(3) The face gear according to (1), wherein the face gear is used in a winding drive mechanism of a fishing reel.

(4) A mold for molding a face gear for transmitting power between two shafts which are perpendicular to each other in an offset state comprising:

a portion, for molding a plurality of tooth portions of the face gear, formed by a numerical controlled milling machine.

(5) The mold according to (4), wherein the face gear is used in a winding drive mechanism of a fishing reel.

(6) A mold-fabricating electrode for manufacturing a mold for molding a face gear for transmitting power between two shafts which are perpendicular to each other in an offset state comprising:

a portion, corresponding to a plurality of tooth portions of the face gear, formed by a numerical controlled milling machine.

(7) The mold-fabricating electrode according to (6), wherein the face gear is used in a winding drive mechanism of a fishing reel.

(8) A method of manufacturing a face gear for transmitting power between two shafts which are perpendicular to each other in an offset state, the method comprising a step of:

utilizing a numerical controlled milling machine to form a plurality of tooth portions of the face gear.

(9) The method according to (8), wherein the face gear is directly machined by the numerical controlled milling machine to form the plurality of tooth portions.

(10) The method according to (8), wherein the numerical controlled milling machine machines a mold so as to form a portion for molding the plurality of tooth portions.

(11) The method according to (8), wherein the numerical controlled milling machine machines a mold-fabricating electrode for manufacturing a mold so as to form a portion corresponding to the plurality of tooth portions.

(12) The method according to (8), wherein an inclined surface is formed on a reverse surface of a surface on which the plurality of tooth portions are formed, and at least a portion of the reverse surface located substantially directly in the rear of the plurality of tooth portions is formed into a flat surface parallel to the surface on which the plurality of tooth portions are formed.

(13) The method according to (8), wherein the face gear is used in a winding drive mechanism of a fishing reel.

(14) The method according to (9), wherein the numerical controlled milling machine machines the plurality of tooth portions so as to form a plurality of stepped portions on each of the plurality of tooth portions.

(15) The method according to (14) further comprising the step of crushing the plurality of stepped portions so as to form a hardened layer.

(16) A face gear for transmitting power between two shafts which are perpendicular to each other in an offset state comprising:

a plurality of tooth portions formed on a first surface of the face gear;

an inclined surface formed on a reverse surface of the first surface; and

a flat surface parallel to the first surface which is formed at at least a portion of the reverse surface located substantially directly in the rear of the plurality of tooth portions.

(17) A gear for transmitting winding power provided in a fishing reel comprising:

a plurality of tooth portions formed on the gear; and

a plurality of stepped portions formed on a surface of each of the plurality of tooth portions.

(18) The gear according to (17), wherein a depth of each of the plurality of stepped portions is 1 to 5 μm.

(19) The gear according to (17), wherein the plurality of stepped portions are perpendicularly or parallel to on of a direction of a tooth trace and a tooth bearing direction of a gear meshing with the gear.

(20) The gear according to (17), wherein the gear is a face gear provided on a handle shaft in a spinning reel for fishing and meshes with a pinion gear.

(21) A gear for transmitting power provided in a winding drive mechanism in a fishing reel comprising:

a plurality of tooth portions formed on the gear; and

a hardened layer formed on a surface of each of the plurality of the gear.

(22) The gear according to (21), wherein the hardened layer is formed by forming a plurality of stepped portions on the surface of each of the plurality of tooth portions and crushing the plurality of stepped portions.

(23) The gear according to (21), wherein the hardened layer includes achemically or physically generated surface treatment layer.

(24) The fishing reel according to (21), wherein the gear is a face gear used in the winding drive mechanism.

### BRIEF DESCRIPTION OF THE DRAWINGS

FIG. 1 is a partially cross-sectional view, taken from the rearward direction, of a spinning reel for fishing having a face gear in accordance with the invention;

FIGS. 2A and 2C are diagrams sequentially illustrating the steps of manufacturing the face gear in accordance with the invention;

FIG. 3 is a diagram illustrating a state when tooth portions of the face gear in accordance with the invention are formed by an NC milling machine;

FIG. 4 is an enlarged view of a tooth portion shown in FIG. 3;

FIG. 5 is a diagram illustrating another method of manufacturing the face gear in accordance with the invention;

FIG. 6 is a diagram illustrating a method of fabricating a mold shown in FIG. 5;

FIG. 7 is a diagram illustrating a method of manufacturing a face gear, according to a second embodiment of the invention, used in the power transmitting mechanism of the spinning reel for fishing shown in FIG. 1;

FIG. 8 is an enlarged view of a tooth portion of the face gear, and illustrates a first example of the construction of a plurality of steps formed on the tooth portion;

FIG. 9 is an enlarged view of the tooth portion of the face gear, and illustrates a second example of the construction of the plurality of steps formed on the tooth portion;

FIG. 10 is an enlarged view of the tooth portion of the face gear, and illustrates a third example of the construction of the plurality of steps formed on the tooth portion;

FIG. 11 is an enlarged view of the tooth portion of the face gear, and illustrates a fourth example of the construction of the plurality of steps formed on the tooth portion;

FIG. 12 is an enlarged view of the tooth portion of the face gear, and illustrates a fifth example of the construction of the plurality of steps formed on the tooth portion;

FIG. 13 is a diagram illustrating a method of manufacturing a face gear used in the spinning reel shown in FIG. 1;

FIG. 14 is an enlarged view of a tooth portion of the face gear, and illustrates a first example of the construction of a plurality of steps formed on the tooth portion;

FIG. 15 is an enlarged view of the tooth portion of the face gear, and illustrates a second example of the construction of the plurality of steps formed on the tooth portion;

FIG. 16 is a diagram illustrating a state in which the stepped portions shown in FIGS. 14 and 15 are subjected to lapping;

FIG. 17 is an enlarged view of the tooth portion of the face gear, and illustrates a third example of the construction of the plurality of steps formed on the tooth portion;

FIG. 18 is an enlarged view of the tooth portion of the face gear, and illustrates a fourth example of the construction of the plurality of steps formed on the tooth portion;

FIG. 19 is a diagram illustrating a state in which the stepped portions shown in FIGS. 17 and 18 are subjected to lapping;

FIG. 20A is an enlarged view of the tooth portion of the face gear, and illustrates a fifth example of the construction of the plurality of steps formed on the tooth portion;

FIG. 20B is a diagram illustrating a state in which the stepped portions shown in FIG. 20A are subjected to lapping;

FIG. 21A is an enlarged view of the tooth portion of the face gear, and illustrates a sixth example of the construction of the plurality of steps formed on the tooth portion;

FIG. 21B is a diagram illustrating a state in which the stepped portions shown in FIG. 21A are subjected to lapping; and

FIG. 22 is a diagram in which a hardened layer is formed on the surface of a tooth portion of a gear used in a fishing reel.

### DETAILED DESCRIPTION OF PREFERRED EMBODIMENTS

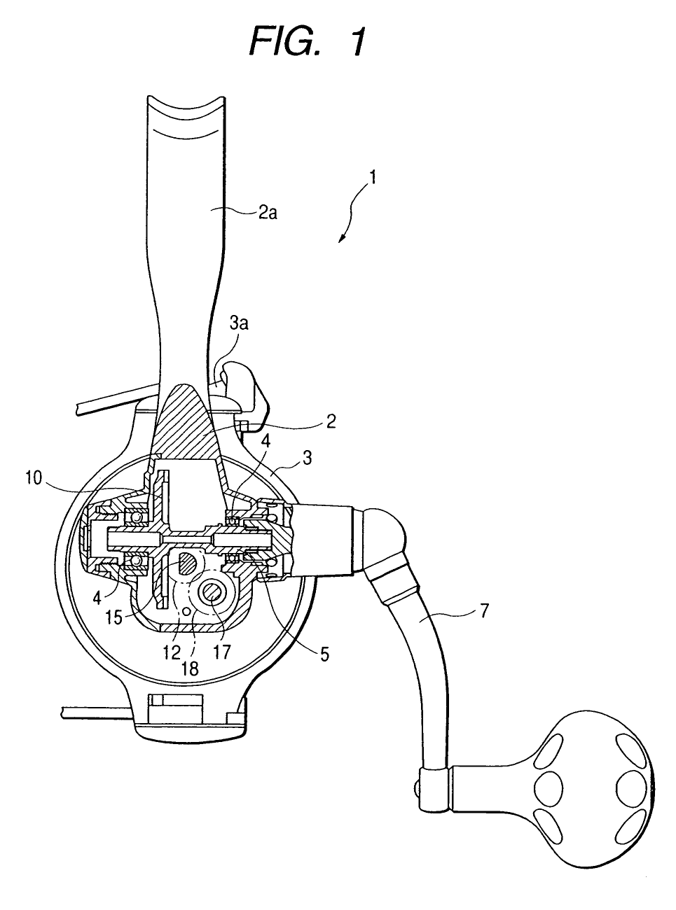

FIG. 1 is a partial cross-sectional view, taken from the rearward direction, of a spinning reel for fishing of an open face type having a face gear in accordance with the invention.

First, a description will be given of the construction and operation of this spinning reel for fishing.

A spinning reel for fishing 1 includes a reel body 2 on which a leg portion 2a for fitting to a fishing rod, a rotor 3 disposed rotatably on a front side of the reel body, and a spool (not shown) disposed in such a manner as to be capable of moving back and forth in synchronism with the rotary motion of the rotor 3.

A handle shaft 5 is rotatably supported in the reel body 2 by means of a bearing 4, and a handle 7 is attached to its projecting end portion. A winding drive mechanism is engaged with the handle shaft 5, and includes a face gear 10 which is fitted to the handle shaft 5 and a pinion 12 which is in mesh with this face gear 10, extends in a direction perpendicular to the handle shaft 5, and has an axially extending hollow portion formed therein.

The pinion gear 12 is rotatably supported in the reel body by means of the bearing in such a manner as to be perpendicular to the handle shaft 5 in an offset state. A spool shaft 15, which extends in a direction perpendicular to the handle shaft 5 and has a spool attached thereto on its distal end side, is inserted in the hollow portion of this pinion 12 so as to be axially movable.

An oscillating mechanism for moving the spool shaft back and forth is engaged with the pinion 12. This oscillating mechanism includes a worm shaft 17 supported rotatably in the reel body and extending in parallel with the spool shaft 15 as well as a gear 18 attached to one end portion of this worm shaft 17 and meshing with the pinion 12. A slider (not shown) engaged with a helical groove of the worm shaft 17 is fixed to the other end portion of the spool shaft 15. The spool shaft 15 is reciprocated back and forth by means of the slider as the worm shaft 17 is driven by a gear 18 and rotated.

By virtue of the above-described construction, as the winding operation of the handle 7 is performed, the rotor 3 is driven by means of the winding drive mechanism and rotated, and the spool is moved back and forth by means of the oscillating mechanism, so that the fishing line is uniformly wound around the spool through a fishing line guide portion 3a provided on the rotor 3.

First Embodiment

Next, a detailed description will be given of the face gear 10, according to a first embodiment of the invention, provided on the handle shaft 5 in the spinning reel for fishing constructed as described above.

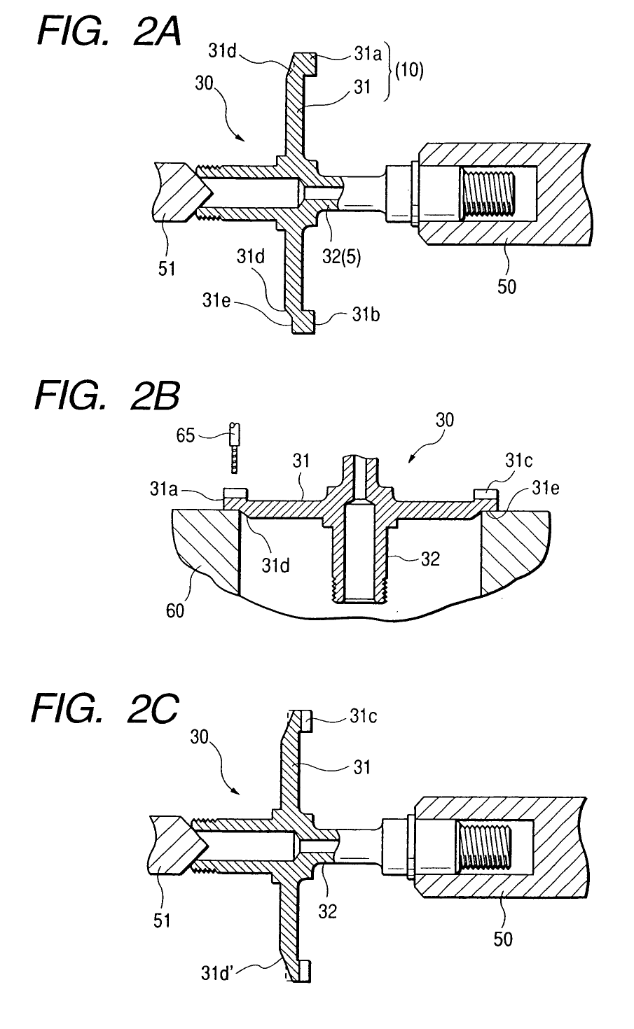

In this embodiment, the face gear 10 is formed integrally with the handle shaft 5. In fabricating such a face gear, a structural member 30 such as the one shown in FIG. 2A is first fabricated in advance by casting, forging, cutting, or the like. In this case, the structural member 30 has a disk portion 31 and a shaft portion 32 extending in such a manner as to be perpendicular to the disk portion 31 at its center. As the disk portion 31 is machined as described below, the face gear integrated with the handle shaft is formed. It should be noted that an annular protrusion 31a is formed on a rim of the disk portion 31, and a plurality of tooth portions 31c are formed on a flat surface 31b of that protrusion, as will be described below, thereby forming the face gear 10. The shaft portion 32 serves as the handle shaft 5 as it is.

Alternatively, apart from the above-described arrangement, an arrangement is possible in which the face gear shaft and the disk portion having face gear tooth surfaces, for example, are formed by separate members and are integrally attached and fixed.

As for the structural member 30, as shown in FIG. 2A, pre-machining is performed in a state in which alignment has been effected with one end of the shaft portion 32 fixed by a chuck 50 and the other end thereof pressed by a pressing portion 51. In this pre-machining, cutting is effected such that an inclined portion 31d which is inclined downward halfway in a direction toward the peripheral edge is formed on the reverse surface side of the annular protrusion 31a, and a flat portion 31e which is parallel with the flat surface 31b is formed on the peripheral edge side starting midway from that inclined portion. Specifically, as shown on the upper side in FIG. 2A, cutting is first performed to form the inclined portion 31d, and, as shown on the lower side, cutting is subsequently performed to form the flat portion 31e on the peripheral edge side starting midway from the inclined portion 31d. Incidentally, the reason for and the advantage of effecting such pre-machining will be described later. In addition, the inclined portion 31d and the flat portion 31e may be formed in advance together with the structural member 30.

However, in the case of casting and forging, it goes without saying that if the accuracy of the mold or die assembly is high, the above-described pre-machining is not necessary, in which case it suffices if the flat portion is formed in advance in the mold or die assembly.

As for the structural member 30 provided with the above-described pre-machining, a substantially directly reverse portion of the protrusion 31a is placed on a work table 60 of a numerically controlled (NC) milling machine, and the flat surface 31b of the protrusion 31a is subjected to machining by a tool 65, as shown in FIGS. 2B, 3, and 4.

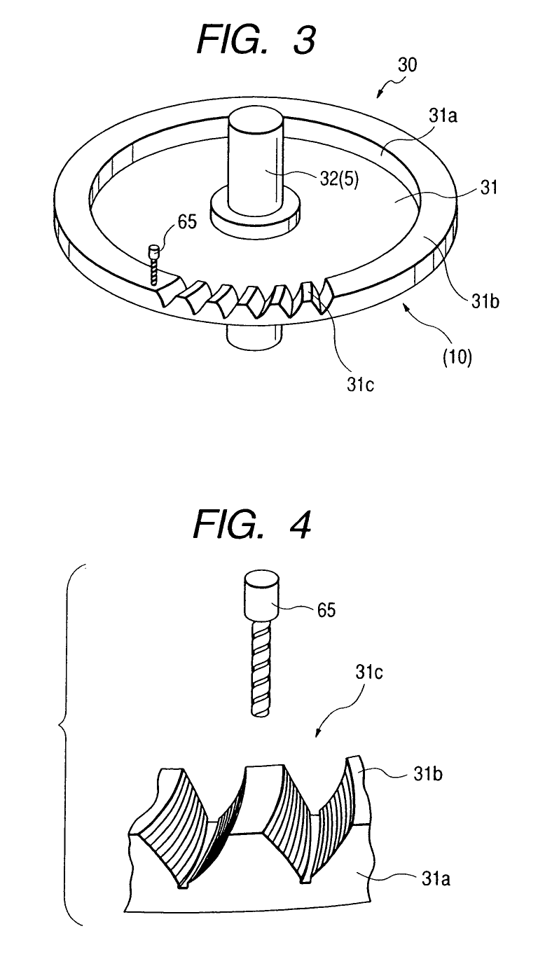

A tooth profile for the face gear which has been analyzed in advance is inputted in advance to a numerical controller connected to the NC milling machine, and the cutting of the tooth portions is effected on the basis of the inputted information. In this case, as the tool 65 effects cutting while moving along the direction of a tooth trace, as shown in FIGS. 3 and 4, the tooth portions 31c are formed on the flat surface 31b, and the face gear 10 is finally fabricated.

As described above, since the tooth portions of the face gear 10 are directly machined by using the NC milling machine, the following steps which are conventionally required become unnecessary: the step of fabricating a pinion cutter by a hob, the step of fabricating an electrode having the tooth profile of the face gear by pressing the pinion cutter against a copper material, and the step of fabricating the mold or die assembly for the face gear by using this electrode. Namely, since the formed article is finished by a single process of working, the error during the manufacturing process is difficult to occur, so that high-accuracy products can be manufactured on a stable basis, and their manufacturing process can be simplified.

The spinning reel for fishing in which such a face gear is used has a characteristic that a large load is applied to the face gear portion at the time of winding when a fish has been caught, so that it is desirable to use a basic material having high strength and wear resistance. With the conventional manufacturing method, however, since the materials are limited as described before, there have been problems in that the tooth surface becomes damaged or worn, causing a decline in the rotating performance, and that the mold or die assembly transferability is poor, including the occurrence of shrinkage and the falling off of edge portions during molding or forming using the mold or die assembly. However, according to the machining method using the NC milling machine, since the basic material is not limited as described above, it becomes possible to use a high-strength, wear-resistant basic material. In addition, since the tooth portions are not formed by transfer, but the tooth portions are formed by direct cutting, variations and the like of the tooth portions are practically nil, so that it is possible to prevent a decline in the rotating performance.

As the basic material of the face gear, it is possible to use various kinds of materials such as aluminum, brass, stainless steel, titanium, titanium alloys, and copper alloys and without being limited to these materials mentioned. In the case of the spinning reel for fishing, however, since the number of revolution of the pinion gear meshing therewith is high, it is preferable to use a basic material whose strength is lower than that of the basic material used for the pinion gear. In addition, by using a high-strength material for the face gear, it becomes possible to increase the number of teeth and adopt a small module (m≦0.6). Consequently, it becomes possible to obtain a smooth rotational characteristic by increasing the contact ratio and to make the reel body compact.

Since the tooth portions are formed by analyzing the tooth profile and inputting its program data, the correction of tooth traces and the change of the gear ratio can be coped with by merely changing the input data, so that different face gears can be manufactured easily. In addition, since deburring can be coped with by initial inputting of data, the finishing of the tooth surfaces is made possible in a single process, so that it becomes possible to easily obtain high-accuracy products. In addition, since the accuracy of the completed product as the face gear is higher than that of the conventional product, it becomes possible to substantially reduce the time concerning lapping finishing, thereby making it possible to simplify the manufacturing process.

It should be noted that, according to the above-described machining using the NC milling machine, a plurality of stepped portions (kerfs) come to be formed on the respective surfaces of the tooth portions 31c along a tooth trace, as shown in FIG. 4. In this case, the surfaces can be hardened by crushing the stepped portions by the above-described lapping finishing, thereby making it possible to improve the durability and wear resistance.

In the spinning reel for fishing, it is the general practice to form an inclined surface sloping downward toward the outer edge particularly on the directly reverse portion of the tooth surface of the face gear (see the inclined portion 31d in FIG. 2A) for reasons such as to make the shape of the reel body compact.

However, if such an inclined surface is formed, the area of the portion supporting the tooth portion decreases, and the face gear is deflected at the time of the above-described machining of the tooth surfaces. Consequently, there can occur defects such that the worked surface becomes deformed and that the depth of the cut tooth portions becomes different. In addition, such defects also occur during lapping which is performed after the working based on casting and forging in general, with the result that the problem of the decline in the accuracy of the tooth surface occurs.

In contrast, by providing in advance pre-machining to form the flat portion 31e parallel with the tooth surface on the reverse side of the annular protrusion 31a, as shown in FIG. 2B, the flat surface 31e serves as a base during the process of the formation of the tooth portions or during the process of lapping, and make it possible to effect the cutting process in a stable state, thereby making it possible to eliminate the occurrence of the distortion and improve the accuracy of the tooth surfaces. It should be noted that this flat portion 31e may be finally subjected to machining, as shown in FIG. 2C, and may be formed as an inclined portion 31d′.

Although in the above-described embodiment the tooth portions are formed by the NC milling machine in the fabrication of the face gear 10, in a case where the face gear is formed by casting or forging, the tooth portions of the mold or die assembly should also preferably be formed in advance by the NC milling machine.

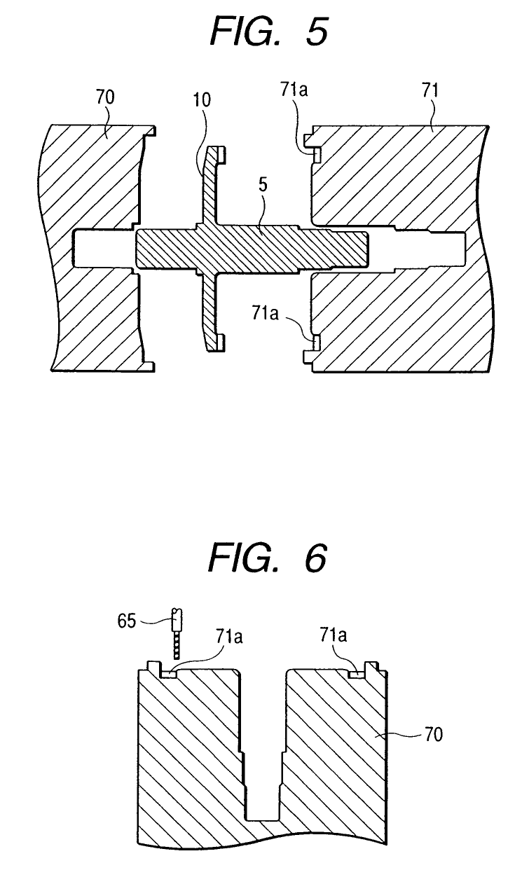

Namely, as shown in FIG. 5, in dies 70 and 71 for forming the face gear 10 having the handle shaft 5, the portions (tooth portions 71a) for forming the tooth portions of the face gear may be formed in advance by the NC milling machine, as shown in FIG. 6.

Since the adoption of such an arrangement decreases the number of transfers at the time of forming the tooth profile (since the step in which a pinion cutter is fabricated by a hob and the step in which an electrode for a mold is fabricated by this pinion cutter are absent), it is possible to improve the accuracy of the tooth portions which are finally formed.

Still alternatively, if the tooth portions of the electrode for fabricating the mold or die assembly are formed in advance by the NC milling machine, the number of transfers when the tooth profile is formed is reduced (since there is no process in which the cutter is fabricated by the hob), it is also possible to improve the accuracy of the tooth portions which are finally formed.

It should be noted that the invention is also applicable to gears other than the above-described face gear and face gears other than that of the spinning reel for fishing of an open face type, such as a face gear of a spinning reel for fishing of a closed face type.

In accordance with the first embodiment of the invention, concerning a face gear which is used mainly in a spinning reel for fishing, it becomes possible to obtain one in which the accuracy of the tooth portions is high. Furthermore, in accordance with the invention, it becomes possible to manufacture high-accuracy face gears easily on a stable basis.

Second Embodiment

Next, a detailed description will be given of the face gear 10, according to a second embodiment of the invention, provided in the handle shaft 5 in the spinning reel for fishing constructed as described above.

The second embodiment of the invention is characterized in that a plurality of stepped portions are formed on the surfaces of the tooth portions of the gear in the winding drive transmitting mechanism. In this embodiment, the tooth portions of the face gear 10 are subjected to machining in advance to form the plurality of stepped portions (these stepped portions are preferably formed continuously and uniformly with predetermined directionality), thereby making it possible to easily hold grease. Namely, by forming the plurality of stepped portions described above, it is possible to hold grease between the stepped portions. Thus, even if the grease comes into contact with the pinion gear, the grease is prevented from being forced out (the grease holding capability increases), so that it is possible to effectively prevent the seizure, wear, and the like between the tooth surfaces of the pinion gear and the face gear attributable to the running out of an oil film. Incidentally, Teflon (trademark) is preferably added in advance to the grease which is applied to the face gear. By adding such Teflon in advance, it is possible to improve lubricity, improve the durability further, and obtain a smooth rotational characteristic.

In addition, since apices formed by the stepped portions are brought into point contact or line contact wit the pinion gear, the area of contact between the two gears decreases. Consequently, the resistance in driving the handle becomes small, so that the winding force becomes light (even if a high-speed gear ratio is arranged, the winding force can be made light).

Specifically, as for the stepped portions formed as described above, in the case where the stepped portions are formed continuously, if the depth of the stepped portion, D, i.e., the distance from the bottom of the stepped space to a midpoint between two adjacent apices of the stepped portions, is set to 1 to 5 μm or thereabouts, it becomes possible to hold the grease sufficiently without causing an uneasy feeling such as a rough feeling during the rotation. Hence, it becomes possible to improve the durability without impairing a pleasant feeling of use. In addition, as for the continuously formed stepped portions, in a case where the stepped portions are made uniform to make the state of contact stable, it suffices if the stepped portions are formed such that their pitch P becomes 5 to 50 μm or thereabouts. Furthermore, it is preferable to form the stepped portions with fixed directionality.

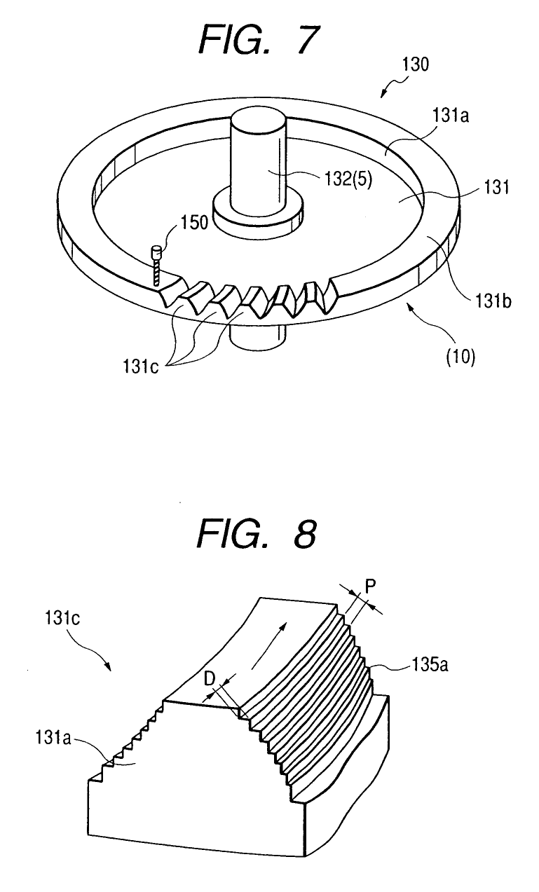

In this embodiment, as shown in FIG. 7, the tooth portions are formed by taking note of the fact that the portion of the face gear where the tooth portions are formed is flat and permits machining by the NC milling machine. According to machining by a tool of the NC milling machine, continuous stepped portions with directionality can be easily formed in working.

Namely, a structural member 130 such as the one shown in FIG. 7 is fabricated in advance by casting, forging, machining, or the like. In this case, the structural member 130 has a disk portion 131 and a shaft portion 132 projecting from the center of the disk portion 131 perpendicularly thereto, and an annular protrusion 131a is formed at the rim of the disk portion 131. A flat surface 131b of the protrusion 131a is subjected to machining by a tool of the NC milling machine to form tooth portions 131c, thereby generating the face gear 110. In addition, the shaft portion 132 is used as it is as the handle shaft 5.

As for the above-described structural member 130, a substantially directly reverse portion of the protrusion 31a is placed on a work table of the NC milling machine, and the tooth portions 131c are formed as the driving of an end mill 150, i.e., a kind of tool, in the X, Y, and Z directions with respect to the flat surface 131b is controlled. The tooth profile for the face gear analyzed in advance has been inputted to a numerical controller connected to the NC milling machine, and the cutting of the tooth portions 131c is effected on the basis of the inputted information.

In this case, the structure of the stepped portions formed on the surfaces of the tooth portions can be changed variously according to the structure of a cutting blade (a flat end mill, a ball end mill, or the like) attached to the end mill 150 and a method of controlling the driving of the end mill 150.

For example, FIG. 8 shows an example in which the tooth portion 131c is formed by controlling the driving of a flat end mill along the direction of the tooth trace indicated by the arrow and by controlling the driving in the perpendicular direction for each stroke. According to such driving control, the tooth portions can be easily formed, and uniform and continuous step-like stepped portions 135a with directionality are formed on the surface in such a manner as to be parallel with the direction of the tooth trace indicated by the arrow. In addition, FIG. 9 shows an example in which the tooth portion 131c is formed by using a ball end mill. In this case, uniform and continuous arcuate stepped portions 135b with directionality are formed on the surface of the tooth portion in such a manner as to be parallel with the direction of the tooth trace indicated by the arrow.

It should be noted that after the above-described stepped portions are formed, the surfaces can be crushed by lapping or the like to form work-hardened layers on the surfaces. By forming such work-hardened layers in advance, it becomes possible to improve the durability further. It goes without saying that, in performing such lapping, the surface should not be completely flattened, but should be made such that continuous stepped portions are formed within the range of the aforementioned depth D.

FIGS. 10 to 12 show examples of various configurations in which the directionality of the stepped portions which are formed on the tooth surfaces together with the tooth portions is varied by variously changing the method of controlling the driving of the end mill of the aforementioned NC milling machine.

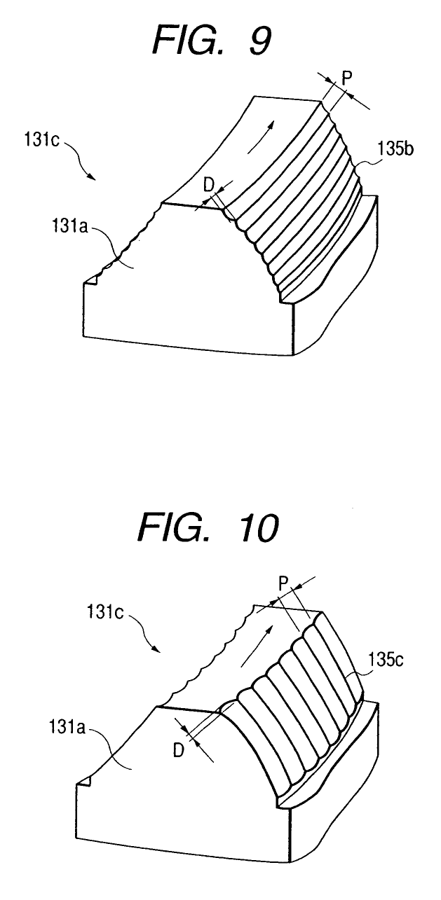

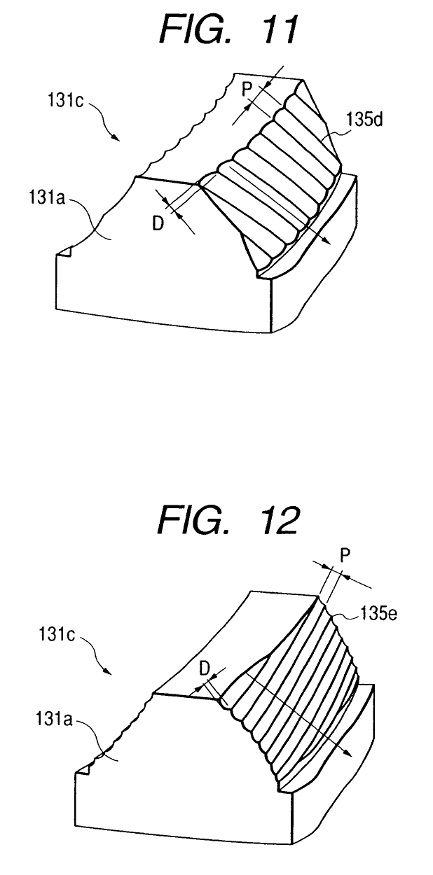

FIG. 10 shows an example in which continuous arcuate stepped portions 135c are formed by the ball end mill in a direction perpendicular to the direction of the tooth trace indicated by the arrow. FIG. 11 shows an example in which continuous arcuate stepped portions 135d are formed by the ball end mill in a direction parallel to the tooth bearing direction of the pinion gear meshing with the face gear. FIG. 12 shows an example in which continuous step-like stepped portions 135e are formed by the ball end mill along a direction perpendicular to the direction of the tooth bearing direction of the pinion gear meshing with the face gear.

Thus the directionality of the stepped portions formed continuously on the tooth surfaces can be changed variously. By forming the stepped portions perpendicularly or parallel to one of the direction of the tooth trace and the tooth bearing direction of the pinion gear as described above, it is possible to enhance the grease holding effect while effectively reducing the contact resistance between the tooth surfaces of the pinion gear and the face gear. Hence, it becomes possible to remarkably improve the durability due to the reduction of the winding drive resistance and the prevention of tooth surface wear. In particular, as shown in FIGS. 10 and 11, if the stepped. portions are formed along the tooth bearing direction of the pinion gear, the pinion gear moves in a sliding manner in this direction, and since the burden on the tooth surfaces can be minimized, this arrangement is more preferable in terms of the durability and wear resistance.

It goes without saying that, in the examples of the construction shown in FIGS. 10 to 12 as well, the surfaces may be crushed by lapping or the like to form work-hardened layers on the surfaces.

Although in the above-described embodiment the plurality of stepped portions are formed in advance with regularity with a predetermined pitch, the stepped portions may not be provided with regularity in a strict sense. Furthermore, although the open type is illustrated as the face gear, the invention is also applicable to the spinning reel for fishing having a closed-type face gear.

In addition, the invention is also applicable to fishing reels of other types having power transmitting gears, such as a double-bearing reel.

According to the fishing reel of the second embodiment of the invention, it becomes possible to hold grease between the stepped portions on the tooth surfaces of the gear for power transmission. In addition, since the contact between this gear and a gear meshing therewith decreases, the durability of the gear improves, and light handle operation can be performed.

Third Embodiment

A third embodiment of the invention is characterized in that the hardened layer is formed on the surface of each tooth portion of the gear. In this embodiment, the tooth portions of the face gear 10 are subjected to machining in advance to form the plurality of stepped portions (these stepped portions are preferably formed continuously with predetermined directionality), and by subsequently crushing the stepped portions, hardened layers thicker than conventional work-hardened layers are formed to improve the strength of the tooth surfaces and improve wear resistance and durability. Namely, by continuously forming the plurality of stepped portions with directionality, it is possible to increase areas to be crushed without causing variations in the profile of the tooth surface. Correspondingly, it becomes possible to form thick work-hardened layers as compared with the case where the flat portions and the uneven surfaces are crushed.

Specifically, the stepped portions which are thus formed continuously are preferably formed such that their pitch becomes 5 to 50 μm or thereabouts, and their depth becomes 1 to 5 μm or thereabouts. Namely, if the pitch and the depth are smaller than the just-mentioned lower limits, it becomes impossible to obtain sufficiently hardened layers. On the other hand, if the pitch and the depth are greater than the aforementioned upper limits, time and trouble are required in the crushing process, and it becomes difficult to crush the stepped portions sufficiently.

In the third embodiment, as shown in FIG. 13, the tooth portions are formed by taking note of the fact that the portion of the face gear where the tooth portions are formed is flat and permits machining by the NC milling machine, and that according to machining by a tool of the NC milling machine, continuous stepped portions with directionality can be easily formed in working.

Namely, first, a structural member 230 such as the one shown in FIG. 13 is fabricated in advance by casting, forging, machining, or the like. In this case, the structural member 230 has a disk portion 231 and a shaft portion 232 projecting from the center of the disk portion 231 perpendicularly thereto, and an annular protrusion 231a is formed at the rim of the disk portion 231. A flat surface 231b of the protrusion 231a is subjected to machining by a tool of the NC milling machine to form tooth portions 231C, thereby generating the face gear 10. In addition, the shaft portion 232 is used as it is as the handle shaft 5.

As for the above-described structural member 230, a substantially directly reverse portion of the protrusion 231a is placed on a work table of the NC milling machine, and the tooth portions 231c are formed as the driving of an end mill 250, i.e., a kind of tool, in the X, Y, and Z directions with respect to the flat surface 231b is controlled. The tooth profile for the face gear analyzed in advance has been inputted to a numerical controller connected to the NC milling machine, and the cutting of the tooth portions 231c is effected on the basis of the inputted information.

In this case, the structure of the stepped portions formed on the surfaces of the tooth portions can be changed variously according to the structure of a cutting blade (a flat end mill, a ball end mill, or the like) attached to the end mill 250 and a method of controlling the driving of the end mill 250.

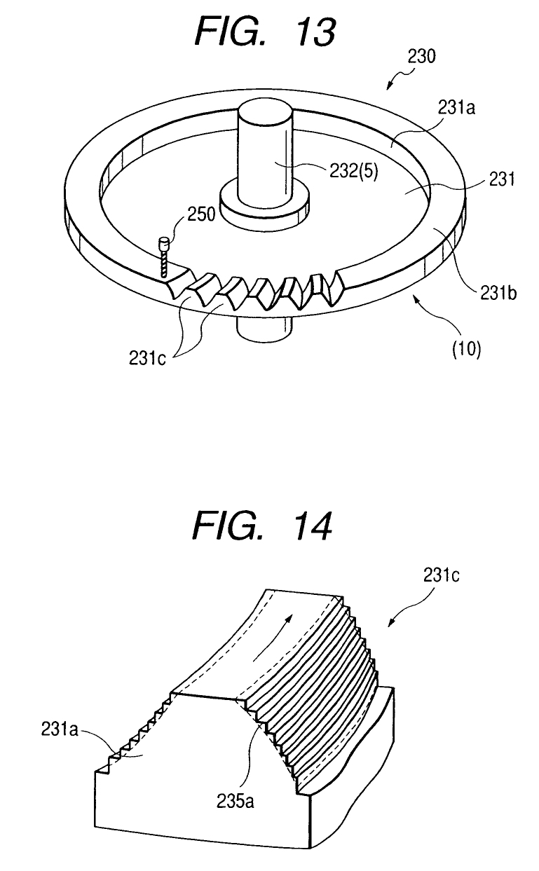

For example, FIG. 14 shows an example in which the tooth portion 231c is formed by controlling the driving of a flat end mill along the direction of the tooth trace indicated by the arrow and by controlling the driving in the perpendicular direction for each stroke. According to such driving control, the tooth portions can be easily formed, and uniform and continuous step-like stepped portions 235a with directionality are formed on the surface along the direction of the tooth trace indicated by the arrow. In addition, FIG. 15 shows an example in which the tooth portion 231c is formed by using a ball end mill. In this case, uniform and continuous arcuate stepped portions 235b with directionality are formed on the surface of the tooth portion along the direction of the tooth trace indicated by the arrow.

After the above-described stepped portions are formed, the surfaces are crushed by lapping or the like as shown in FIG. 16, thereby forming work-hardened layers on the surfaces. In this case, since cutting by the flat end mill shown in FIG. 14 makes it possible to increase areas to be crushed (flat areas) as compared with cutting by the ball end mill shown in FIG. 15, the work-hardened layers (portions indicated by dotted lines in FIGS. 14 and 15) formed at the time of crushing can be made thick. Therefore, the cutting by the flat end mill is preferable in terms of the durability. On the other hand, according to the cutting by the ball end mill, it is possible to improve the accuracy of the tooth portions 231c.

FIGS. 17 to 21 show examples of various configurations in which the directionality of the stepped portions which are formed on the tooth surfaces together with the tooth portions is varied by variously changing the method of controlling the driving of the end mill.

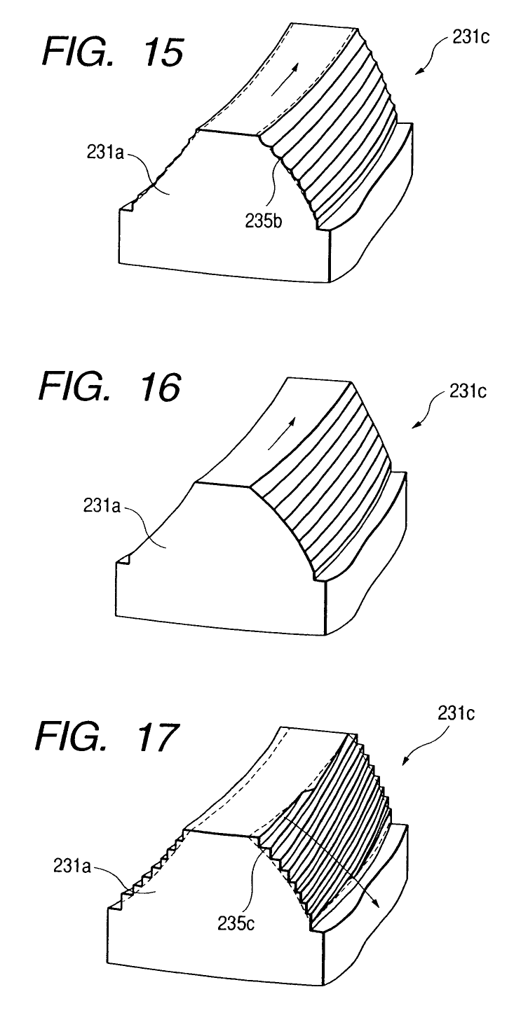

FIG. 17 shows an example in which continuous step-like stepped portions 235c are formed by the flat end mill along a direction perpendicular to the tooth bearing direction (the direction indicated by the arrow) of the pinion gear meshing with the face gear. FIG. 18 shows an example in which continuous arcuate stepped portions 235d are similarly formed by the ball end mill.

After the above-described stepped portions are formed, their surfaces are crushed by lapping or the like as shown in FIG. 19, thereby forming work-hardened layers on the surfaces. In this case, in the same way as the above-described construction, since cutting by the flat end mill shown in FIG. 17 makes it possible to increase the areas to be crushed as compared with cutting by the ball end mill shown in FIG. 18, the work-hardened layers formed at the time of crushing can be made thick. Therefore, the cutting by the flat end mill is preferable in terms of the durability.

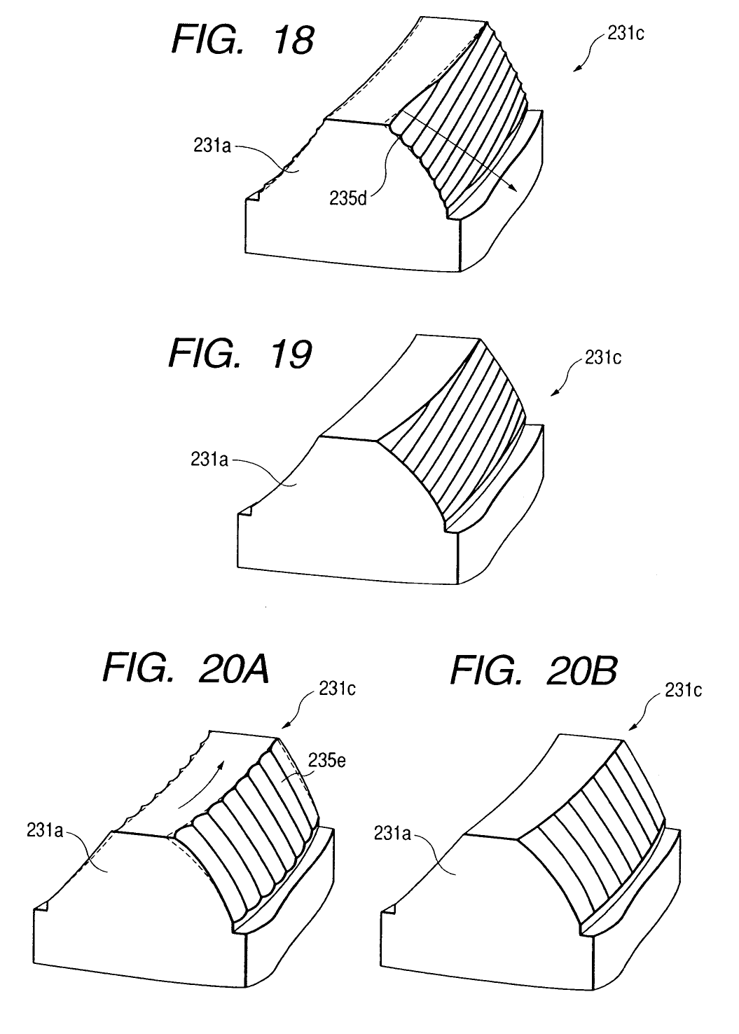

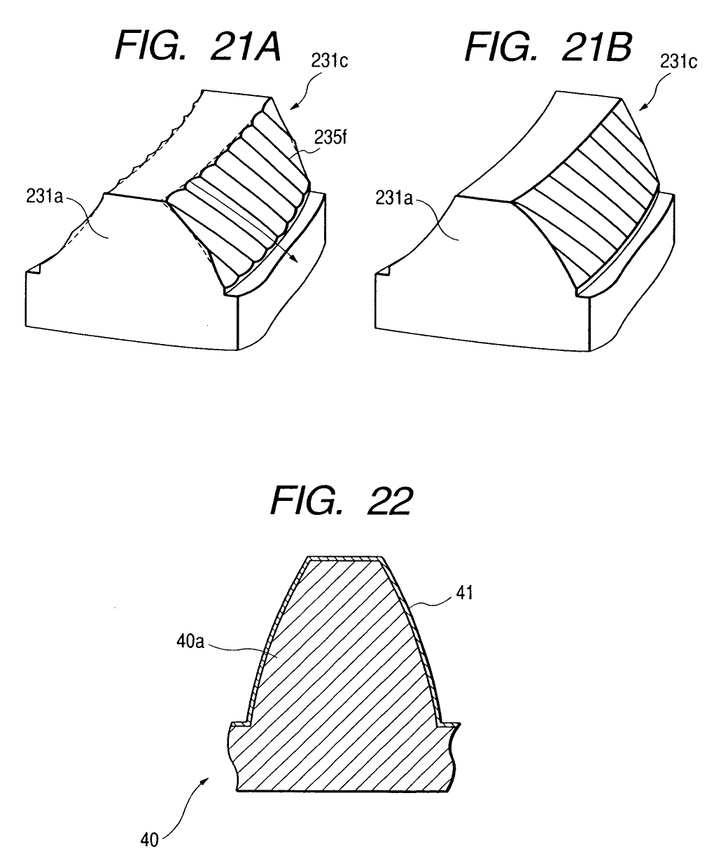

FIG. 20A shows an example in which continuous arcuate stepped portions 235e are formed by the ball end mill along a direction perpendicular to the direction of the tooth trace (the direction indicated by the arrow), while FIG. 20B shows a state in which work-hardened layers are formed on the surfaces by crushing the surfaces by lapping or the like. In addition, FIG. 21A shows an example in which continuous arcuate stepped portions 235f are formed by the ball end mill along the tooth bearing direction (the direction indicated by the arrow) of the pinion gear meshing with the face gear, while FIG. 21B shows a state in which work-hardened layers are formed on the surfaces by crushing the surfaces by lapping or the like.

Thus the directionality of the stepped portions formed continuously on the tooth surfaces can be changed variously. However, if the stepped portions are formed along the tooth bearing direction of the pinion gear as shown in FIG. 21, since the pinion gear moves in such a manner as to slide in this direction, the burden on the tooth surfaces can be minimized by forming the hardened layers oriented in this direction, and this arrangement is most preferable in terms of the durability and wear resistance.

In the above-described embodiment, the face gear of the spinning reel is illustrated as the gear, and the hardened layers formed by flattening based on lapping or the like has been illustrated as the hardened layers formed on the surfaces of the tooth portions. However, as the gear the invention is also applicable to a spur gear, a rack and a pinion, an internal gear, and the like which are incorporated in fishing reels of various kinds. Further, as the means for forming the hardened layers, the hardened layers can be formed by chemical surface treatment or physical surface treatment.

For example, as shown in FIG. 22, a hardened layer 41 may be formed by providing the surface of a tooth portion 40a of a gear 40 with chemical surface treatment, such as nitriding or carburization, or physical surface treatment, such as sputtering, ion plating, induction hardening, shot peening, or the like, directly or after work-hardening treatment or surface treatment such as the one described above has been provided.

If the hardened layer 41 is formed by such chemical or physical surface treatment means, the wear resistance of the tooth portion 40a improves, and it becomes possible to prevent a decline of the rotating performance.

According to the fishing reel of the third embodiment of the invention, it becomes possible to attain improvement of the wear resistance of various gears used in the winding drive mechanism, so that it is possible to obtain a fishing reel whose rotating performance is difficult to decline.

What is claimed is:

1. A face gear for transmitting power between two shafts which are perpendicular to each other in an offset state comprising:
a plurality of tooth portions formed by a numerically controlled milling machine.

2. The face gear according to claim 1, wherein an inclined surface is formed on a reverse side of a surface on which the plurality of tooth portions are formed, and at least a portion of the reverse surface located substantially directly in the rear of the plurality of tooth portions is formed into a flat surface parallel to the surface on which the plurality of tooth portions are formed.

3. The face gear according to claim 1, wherein the face gear is used in a winding drive mechanism of a fishing reel.

4. A mold for molding a face gear for transmitting power between two shafts which are perpendicular to each other in an offset state comprising:
a portion, for molding a plurality of tooth portions of the face gear, formed by a numerical controlled milling machine.

5. The mold according to claim 4, wherein the face gear is used in a winding drive mechanism of a fishing reel.

6. A mold-fabricating electrode for manufacturing a mold for molding a face gear for transmitting power between two shafts which are perpendicular to each other in an offset state comprising:
a portion, corresponding to a plurality of tooth portions of the face gear, formed by a numerical controlled milling machine.

7. The mold-fabricating electrode according to claim 6, wherein the face gear is used in a winding drive mechanism of a fishing reel.

8. A method of manufacturing a face gear for transmitting power between two shafts which are perpendicular to each other in an offset state, the method comprising a step of:
utilizing a numerical controlled milling machine to form a plurality of tooth portions of the face gear.

9. The method according to claim 8, wherein the face gear is directly machined by the numerical controlled milling machine to form the plurality of tooth portions.

10. The method according to claim 8, wherein the numerical controlled milling machine machines a mold so as to form a portion for molding the plurality of tooth portions.

11. The method according to claim 8, wherein the numerical controlled milling machine machines a mold-fabricating electrode for manufacturing a mold so as to form a portion corresponding to the plurality of tooth portions.

12. The method according to claim 8, wherein an inclined surface is formed on a reverse surface of a surface on which the plurality of tooth portions are formed, and at least a portion of the reverse surface located substantially directly in the rear of the plurality of tooth portions is formed into a flat surface parallel to the surface on which the plurality of tooth portions are formed.

13. The method according to claim 8, wherein the face gear is used in a winding drive mechanism of a fishing reel.

14. The method according to claim 9, wherein the numerical controlled milling machine machines the plurality of tooth portions so as to form a plurality of stepped portions on each of the plurality of tooth portions.

15. The method according to claim 14 further comprising the step of crushing the plurality of stepped portions so as to form a hardened layer.

16. A face gear for transmitting power between two shafts which are perpendicular to each other in an offset state comprising:
a plurality of tooth portions formed on a first surface of the face gear;
an inclined surface formed on a reverse surface of the first surface; and
a flat surface parallel to the first surface which is formed at at least a portion of the reverse surface located substantially directly in the rear of the plurality of tooth portions.

17. A gear for transmitting winding power provided in a fishing reel comprising:
a plurality of tooth portions formed on the gear; and
a plurality of stepped portions formed on a surface of each of the plurality of tooth portions.

18. The gear according to claim 17, wherein a depth of each of the plurality of stepped portions is 1 to 5 μm.

19. The gear according to claim 17, wherein the plurality of stepped portions are perpendicularly or parallel to on of a direction of a tooth trace and a tooth bearing direction of a gear meshing with the gear.

20. The gear according to claim 17, wherein the gear is a face gear provided on a handle shaft in a spinning reel for fishing and meshes with a pinion gear.

21. A gear for transmitting power provided in a winding drive mechanism in a fishing reel comprising:
a plurality of tooth portions formed on the gear; and
a hardened layer formed on a surface of each of the plurality of the gear.

22. The gear according to claim 21, wherein the hardened layer is formed by forming a plurality of stepped portions on the surface of each of the plurality of tooth portions and crushing the plurality of stepped portions.

23. The gear according to claim 21, wherein the hardened layer includes a chemically or physically generated surface treatment layer.

24. The fishing reel according to claim 21, wherein the gear is a face gear used in the winding drive mechanism.
